(19) United States
(12) Patent Application Publication
(10) Pub. No.: US 2007/0231073 A1
(43) Pub. Date: Oct. 4, 2007

(54) Method of utilizing high-temp steam and recirculated heat source to separate mercury and crack dioxin and organic substances contained in soil

(76) Inventor: Horng Jiang, Xindian City (TW)

Correspondence Address: BIRCH STEWART KOLASCH & BIRCH, PO BOX 747, FALLS CHURCH, VA, 22040-0747, US

(21) Appl. No.: 11/727,792

(22) Filed: Mar. 28, 2007

(30) Foreign Application Priority Data
Mar. 29, 2006 (TW) 095111020

(51) Int. Cl. B09C 1/02

(52) U.S. Cl. 405/128.7

(57) ABSTRACT

In a method of treating waste soil, carbon-containing substances are added into the soil according to percentages of different organic substances contained in the soil; the soil is then isolated from external air while being fed into a reaction chamber; high-temp hot gas is sent from a first combustion chamber into a second combustion chamber to heat the reaction chamber and a high-temp steam generator; high-temp steam produced by the high-temp steam generator is introduced into the reaction chamber, and maintained in thermal balance with the soil in the reaction chamber, so that mercury, organic substances, and dioxin contained in the soil are distilled and carried away by the high-temp steam; and fuel gas and fuel oil are separated from the steam for sending to a burner for producing the high-temp hot gas; and the treated soil is isolated from external air while being discharged, and quickly cooled down.

### FIELD OF THE INVENTION

The present invention relates to a method of soil reclamation and waste treatment, and more particularly, to a method of utilizing high-temp steam and recirculated heat source to separate mercury and crack dioxin and organic substances contained in soil.

### BACKGROUND OF THE INVENTION

Mercury, dioxin, and organic solvent contained in polluted soil are low in amount, and it is therefore very difficult to treat soil to remove these pollutants. Up to date, there is not any successful and matured soil treatment technique for separating mercury and cracking dioxin at the same time.

Taiwan Patent Publication No. 478979 discloses a non-pollution treatment method and apparatus for converting organic waste into usable resources. The above patent is characterized in that, in a rear stage of waste cracking reaction, a secondary coke cracking reaction is provided, so that coke that is about 80% cracked is output from the reaction chamber to be separately heated to complete the subsequent 20% of refining and remove volatile organic compounds (VOC) remained in the coke.

Coke produced with the above technique is not good in quality, and the apparatus thereof is bulky and used for low-temp cracking process, which tends to cause dioxin pollution and other air pollution problems, and accordingly, requires improvements.

In a conventional way of soil treatment, plasma is utilized to crack dioxin and separate mercury from soil under high temperature, a large amount of energy is consumed, and the apparatus thereof is extremely expensive. And, in another conventional way of soil treatment, chemicals are utilized to treat soil, since the pollutants contained in the soil could not be completely removed in the treatment, secondary pollution would be caused.

It is therefore tried by the inventor to develop a method of utilizing high-temp steam and recirculated heat source to separate mercury and crack dioxin and organic substances contained in soil, so as to eliminate the drawbacks existed in the prior art.

### SUMMARY OF THE INVENTION

A primary object of the present invention is to provide a method of treating soil, in which soil added with carbon-containing substances and high-temp steam are introduced into a reaction chamber, and the reaction chamber is heated by high-temp hot gas for the high-temp steam to maintain thermal balance with the soil and waste being treated, so that mercury is separated from the soil and dioxin and any organic waste contained in the soil are cracked at the same time.

Another object of the present invention is to provide a method of treating soil, in which fuel gas and fuel oil are separated from steam containing mercury, organic substances, and dioxin, and sent to a burner for use as a recirculated heat source, so as to save energy and operation cost in soil treatment.

A further object of the present invention is to provide a method of treating soil, in which waste water produced in cooling process, oil/water separation, and mercury/water separation is heated using high-temp hot gas for producing steam. And, when the high-temp hot gas is cooled down, it is subjected to waste gas treatment with wet scrubber, ion exchange technique, and activated carbon, so that the waste gas emission is zero pollution. Moreover, the waste gas treatment also provides the function of heat exchange.

A still further object of the present invention is to provide a method of treating soil, in which soil is converted to produce activated carbon utilizing high-temp steam and high-temp hot gas.

A still further object of the present invention is to provide a method of treating soil, in which waste water produced in cooling process, oil/water separation, and mercury/water separation is recirculated for use as a source for producing steam, so as to saving energy and operation cost in soil treatment.

To achieve the above and other objects, the method of the present invention treats soil in three stages to effectuate mercury separation, dioxin and organic substances cracking process, and soil reclamation.

In the first stage, different metal boiling points and high-temp distillation is employed for organic and dioxin decomposition and mercury separation.

Generally speaking, in this stage, high-temp hot gas and high-temp steam are utilized at the same time to distill and decompose organic substances. Since steam has very good invasive power, mercury and organic substances, such as dioxin, wrapped in soil can be easily separated from the soil. The high-temp steam is able to suppress the production of carbon black and accordingly increases the production of fuel gas from treated soil, and converts Cl and S contained in the soil, waste, and dioxin into HCl and H₂S, respectively, based on the following principles:

C+H₂O->CO+H₂

nC+mH₂->CnHm

S—+H₂->H₂S

Cl—+H₂->HCl

Due to different specific weights, when the mercury-containing high-temp steam is cooled down, mercury can be very easily separated from the steam and purified, and fuel oil and fuel gas can also be easily separated from the steam. Therefore, the method of the present invention provides a very stable and reliable process. Since the mercury has a boiling point of 357.33° C., and the organic substances has a cracking temperature of 350° C., the high-temp steam used in the present invention must have a temperature higher than the boiling point of mercury to fall between 380° C. and 450° C. The first stage in the method of the present invention is adapted to produce fuel oil and fuel gas and separate mercury from soil. More than 99% of dioxin contained in the treated soil is decomposed.

In the second stage, a high-temp activation technique is employed for soil reclamation. The soil having been treated in the first stage contains a large amount of carbon black having a BET (Brunauer Emmett and Teller Method) about 100. To ensure that the organic substances in the soil are completely decomposed and the mercury in the soil is completely released, and to increase the soil activating power, the high-temp activation process is adopted in the second stage of the present invention.

In the high-temp activation process, a processing temperature is raised to higher than 700° C., and uses steam to activate treated soil. In this manner, activated carbon in the soil shall have an adsorption power in BET more than 500. The treated soil may be directly used to improve soil quality. Soil having been treated in the second stage is found free of dioxin and mercury.

In the third stage, the treated soil is used in land restoration and underground water treatment. That is, the large amount of activated carbon in the treated soil is used as a filter layer to filter rainwater and underground water.

In the method of soil treatment according to the present invention, the soil to be treated and added with carbon-containing substances is isolated from external air and fed into a reaction chamber. High-temp hot gas is introduced from a first combustion chamber into a second combustion chamber to heat the reaction chamber and a high-temp steam generator, both of which are located in the second combustion chamber. High-temp steam produced in the heated high-temp steam generator is sent into the reaction chamber to maintain a thermal balance with the soil in the reaction chamber, so that mercury, organic substances, and dioxin in the soil are distilled and carried away by the steam. The steam containing mercury, organic substances, and dioxin is cooled down at a cooler to separate fuel gas from water containing oil and mercury. The separated fuel gas is adsorbed with activated carbon and sent into a burner for conducting high-temp oxidation in the first combustion chamber, so as to produce the high-temp hot gas. The separated water containing oil and mercury is sent to an oil/water separator for oil/water separation, so that fuel oil is separated from water containing mercury and sent to the burner for producing the high-temp hot gas. The water containing mercury is further sent to a mercury/water separator for mercury/water separation to recover usable mercury, and waste water produced in the cooling and the oil and mercury separation is recirculated to the high-temp stream generator for producing the high-temp steam. The high-temp hot gas in the second combustion chamber is cooled down but may still be used to heat the high-temp steam generator to help in the production of high-temp steam. The waste gas discharged from the high-temp steam generator is subjected to waste gas treatment by wet scrubber, ion exchange technique, and activated carbon, so that waste gas emission from the present invention is zero pollution. The treated soil is isolated from external air while being discharged from the reaction chamber and is quickly cooled down.

In the method of the present invention, hot gas is recirculated for producing high-temp steam, and high-temp steam and high-temp hot gas are used in mercury separation and dioxin and organic cracking to produce recycled energy, that is, the fuel gas and fuel oil, which is then utilized to produce the high-temp hot gas. With these recirculation arrangements, the cost for soil treatment is largely reduced, and the treated soil contains high amount of activated carbon with high adsorption power and is therefore suitable for soil reclamation, waste water filtering, and vegetation restoration.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart illustrating a method of utilizing high-temp steam and recirculated heat source to separate mercury and crack dioxin and organic substances contained in soil according to the present invention.

### DETAILED DESCRIPTION OF THE PREFERRED EMBODIMENTS

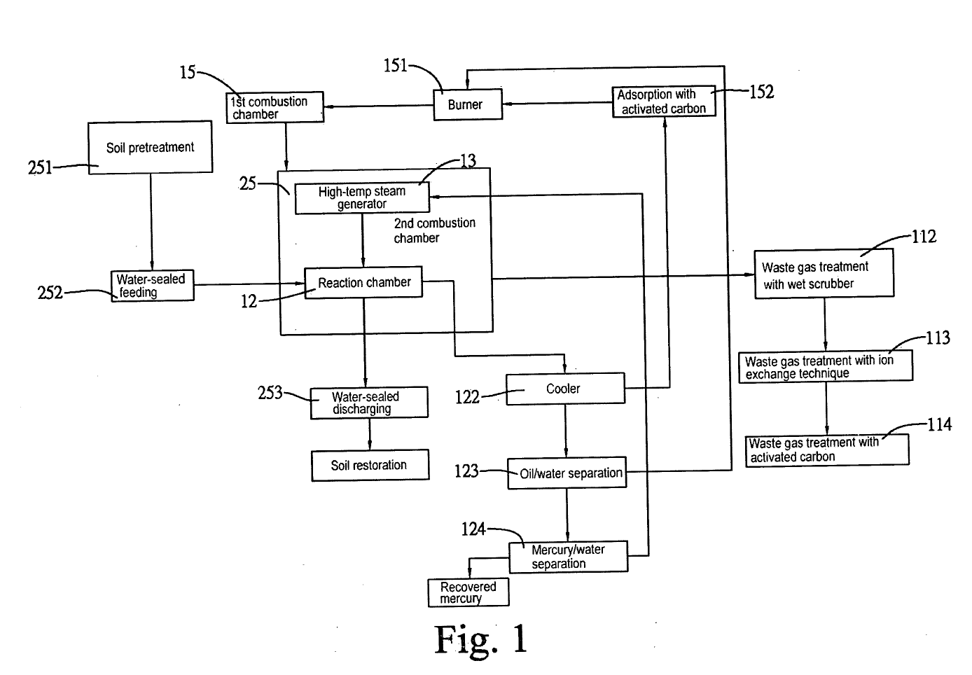

A method of utilizing high-temp steam and recirculated heat source to separate mercury and crack dioxin and organic substances contained in soil according to a preferred embodiment of the present invention is now explained with reference to FIG. 1 that is a flowchart illustrating the method of the present invention.

### I. Soil Pre-Treatment 251

Since the amounts of different organic substances contained in soil are low, a large amount of energy is required and consumed in soil treatment. To reduce energy consumption in soil treatment as much as possible, and to allow the reclaimed soil to contain a large amount of activated carbon, it is necessary to add carbon-containing substances into the soil to be treated. The carbon-containing substances may include, for example, organic-containing substances, dioxin-containing substances, mercury-containing substances, plastic-containing substances, rubber-containing substances, coal, oil, kitchen residues, agricultural waste, animal waste, carbon black, activated carbon, etc. Ratios of addition of these carbon-containing substances vary with the percentages of organic substances contained in the soil to be treated.

### II. Water-Sealed Feeding 252

To prevent external air from entering a reaction chamber 12 in which the soil is treated, high-temp steam decomposition technique, water sealing, and gate control are adopted in the method of the present invention, and spiral feeder with relatively large tooth pitch and inclination is used to feed the soil. When the spiral feeder is actuated to turn, soil to be treated and added with carbon-containing substances is spirally fed into the reaction chamber 12.

### III. First-Stage Treatment

The reaction chamber 12 is a thermal cracking reaction chamber, in which soil added with carbon-containing substances is subjected to the first-stage treatment. At this point, high-temp hot gas coming from a first combustion chamber 15 having a temperature higher than 1000° C. is sent into a second combustion chamber 25 to heat the reaction chamber 12 and a high-temp steam generator 13, both of which are located in the second combustion chamber 25, so that the reaction chamber 12 has a temperature higher than 500° C., and the high-temp steam generator 13 produces high-temp steam higher than 400° C., which is sent into the reaction chamber 12 to maintain a thermal balance with the soil added with carbon-containing substances at a temperature higher than 380° C.

When the soil and the high-temp steam are maintained at the thermal balance temperature of 380° C. and higher, mercury, organic substances, and dioxin contained in the soil are distilled and carried away by the steam to pass a cooler 122, at where fuel gas is separated from water containing oil and mercury. The separated oil and mercury contained water is further sent to an oil/water separator for oil/water separation 123, so that fuel oil is separated from water containing mercury. The separated fuel oil is sent to a burner 151, which will be described later, and the mercury-contained water is further sent to a mercury/water separator for mercury/water separation 124, so as to recover usable mercury. The separated waste water is recirculated to the high-temp steam generator 13 for producing the high-temp steam.

The fuel gas separated at the cooler 122 is subjected to adsorption with activated carbon 152, so as to desorb residual mercury vapor from the fuel gas before the fuel gas is sent to the burner 151 for conducting high-temp oxidation in the first combustion chamber 15 and producing a heat source of higher than 1200° C. to produce the high-temp hot gas. It is noted the duration for the 1000° C. oxidation from the first combustion chamber 15 to the second combustion chamber 25 must exceed 2 seconds in order to completely destroy any residual dioxin substance.

### IV. Waste Gas Treatment

The duration from the introduction of the hot gas into the first combustion chamber 15 to the sending of waste gas produced in the second combustion chamber 25 to a wet scrubber for waste gas treatment 112 should not exceed 0.5 second. And, an outlet temperature of the waste gas should not exceed 300° C. to avoid the dioxin in the waste gas from reducing. The high-temp hot gas introduced into the second combustion chamber 25 to heat the reaction chamber 12 and the high-temp steam generator 13 is cooled down and sent to the wet scrubber for waste gas treatment 112 for desulphurization and dechloridation. The waste gas having been treated with the wet scrubber is further subjected to waste gas treatment with ion exchange technique 113 to remove NOₓ, so as to reduce the emission of SOₓ, HCl, and NOₓ to as low as less than 0.5 ppm. Finally, the waste gas is subjected to waste gas treatment with activated carbon 114 to once again remove any possible residual heavy metal or dioxin substances from the waste gas, so that the waste gas emission is zero pollution.

### V. Treatment of Carbon Black and Residual Mercury and Organic Substances in Soil

Since the soil having been treated with the above-mentioned procedures contains a large amount of carbon black, the temperature of the reaction chamber 12 must be raised and maintained at 700° C. and higher to completely decompose the carbon black and any residual mercury and organic substances in the soil into fuel gases, including CO, CnHm, H₂, and H₂O, so that no oil gas would be produced and the carbon black is activated by the steam into activated carbon with high adsorption rate.

### VI. Water-Sealed Discharging 253

The soil having been treated in the reaction chamber 12 is discharged by way of water-sealed discharging in a manner similar to the water-sealed feeding 252. The discharged treated soil is quickly cooled down by way of water annealing, and steam produced in the water annealing is sent into the reaction chamber 12 and used as a steam source for activating the carbon black. The treated and cooled down soil may be directly used in soil reclamation to increase crop growth rate and filter polluted underground water.

The present invention is superior to the prior art in the following aspects:
1. Energy can be recirculated and utilized to reduce power consumption.
2. No secondary pollution would be caused.
3. The treated soil can be used as culture soil and to solve the problem of polluted underground water.
4. It is able to treat mercury, dioxin, and any organic waste at the same time.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of utilizing high-temp steam and recirculated heat source to separate mercury and crack dioxin and organic substances contained in soil, comprising the steps of:
a) adding carbon-containing substances into the soil to be treated, depending on percentages of different organic substances contained in the soil;
b) isolating the soil added with carbon-containing substances from external air while feeding the soil into a reaction chamber;
c) introducing high-temp hot gas from a first combustion chamber into a second combustion chamber to heat the reaction chamber and a high-temp steam generator, both of which are located in the second combustion chamber;
d) introducing high-temp steam produced in the high-temp steam generator into the reaction chamber, and maintaining the high-temp steam in thermal balance with the soil in the reaction chamber, so that mercury, organic substances, and dioxin contained in the soil are distilled and carried away by the high-steam;
e) separating fuel gas and fuel oil from the steam containing mercury, organic substances, and dioxin, and sending the separated fuel gas and fuel oil into a burner for producing the high-temp hot gas for sending into the first combustion chamber; and
f) discharging the treated soil while isolating the soil from external air, and quickly cooling down the discharged soil.

2. The method of utilizing high-temp steam and recirculated heat source to separate mercury and crack dioxin and organic substances contained in soil as claimed in claim 1, wherein, in the step (a), the carbon-containing substances include organic-containing substances, dioxin-containing substances, mercury-containing substances, plastic-containing substances, rubber-containing substances, coal, oil, kitchen residues, agricultural waste, animal waste, carbon black, and activated carbon.

3. The method of utilizing high-temp steam and recirculated heat source to separate mercury and crack dioxin and organic substances contained in soil as claimed in claim 1, wherein the step (e) further includes the step of sending the steam containing mercury, organic substances, and dioxin through a cooler to separate fuel gas from water containing oil and mercury.

4. The method of utilizing high-temp steam and recirculated heat source to separate mercury and crack dioxin and organic substances contained in soil as claimed in claim 3, wherein the separated fuel gas is adsorbed with activated carbon to desorb residual mercury vapor from the gas before being sent to the burner for producing the high-temp hot gas.

5. The method of utilizing high-temp steam and recirculated heat source to separate mercury and crack dioxin and organic substances contained in soil as claimed in claim 3, wherein the separated water containing oil and mercury is sent to an oil/water separator for oil/water separation, so that fuel oil is separated from water containing mercury and sent to the burner for producing the high-temp hot gas.

6. The method of utilizing high-temp steam and recirculated heat source to separate mercury and crack dioxin and organic substances contained in soil as claimed in claim 5, wherein the separated water containing mercury is further sent into a mercury/water separator for mercury/water separation, so as to recovery usable mercury; and waste water produced in the mercury separation is recirculated and sent into the high-temp steam generator for producing the high-temp steam.

7. The method of utilizing high-temp steam and recirculated heat source to separate mercury and crack dioxin and organic substances contained in soil as claimed in claim 1, wherein, in the step (c), the high-temp hot gas cooled down in the second combustion chamber is subjected to waste gas treatment with wet scrubber for desulphurization and dechloridation.

8. The method of utilizing high-temp steam and recirculated heat source to separate mercury and crack dioxin and organic substances contained in soil as claimed in claim 7, wherein the waste gas having been treated with wet scrubber is further subjected to waste gas treatment with ion exchange technique to remove NOₓ, so as to reduce emission of SOₓ, HCl, and NOₓ.

9. The method of utilizing high-temp steam and recirculated heat source to separate mercury and crack dioxin and organic substances contained in soil as claimed in claim 8, wherein the waste gas having been treated with ion exchange technique is further subjected to waste gas treatment with activated carbon, so that any possible residual heavy metal and dioxin substances are removed and the waste gas emission is zero pollution.

10. The method of utilizing high-temp steam and recirculated heat source to separate mercury and crack dioxin and organic substances contained in soil as claimed in claim 1, wherein the soil to be treated and the soil having been treated are fed into and discharged from the reaction chamber, respectively, through water sealing and gate control to isolate the soil from external air.
